(19) United States
(12) Patent Application Publication
(10) Pub. No.: US 2009/0243279 A1
(43) Pub. Date: Oct. 1, 2009

(54) Security device for security substrates

(76) Inventors: Mark Stephen Bundy, Basingstoke (GB); Lawrence George Commander, Reading (GB); Malcolm Robert Murray Knight, Basingstoke (GB); Timothy Edward Berridge, London (GB)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/990,887

(22) PCT Filed: Jul. 21, 2006
(86) PCT No.: PCT/GB2006/002753

§ 371 Date: Feb. 22, 2008

(30) Foreign Application Priority Data
Sep. 29, 2005 (GB) 0519851.0

(51) Int. Cl. B42D 15/00; B42D 15/10

(52) U.S. Cl. 283/85; 283/91; 283/92

(57) ABSTRACT

The invention relates to a security device for security substrates, such as paper, used for making security documents, such as bank notes, having anti-counterfeitable features. The security device comprising a carrier (11) of an at least partially light transmitting polymeric material, said carrier bearing a plurality of fine opaque lines (13) separated by gaps (14). The appearance of the lines is varied at regions, said regions in neighbouring lines combining to provide identifying indicia which are visible to the human eye.

The invention relates to a security device for security substrates, such as paper, used for making security documents, such as bank notes, having anti-counterfeitable features.

It is generally known to include elongate elements in paper or other substrates, usually as a security feature. Such elements can be threads, strips or ribbons of, for example, plastics film, metal foil, metallised plastic, metal wire. These elongate elements are included in the thickness of the substrate to render imitation of documents produced therefrom more difficult. These elements help in the verification of the documents as they render the view of the documents in reflected light different from that in transmitted light. To increase the security provided by the inclusion of such an elongate element, it is also known to endow the element itself with one or more verifiable properties over and above its presence or absence. Such additional properties include magnetic properties, electrical conductivities, the ability to absorb x-rays, fluorescence, optically variable effects and thermochromic behaviour.

As a further security feature, it has been found to be particularly advantageous to provide windows in one side of the surface of the substrate, which expose such elongate elements at spaced locations. Examples of methods of manufacturing paper incorporating security elements with or without windows are described below. It should be noted that references to “windowed thread paper” include windowed paper incorporating any elongate security element.

EP-A-0059056 describes a method of manufacture of windowed thread paper on a cylinder mould paper-making machine. The technique involves embossing the cylinder mould cover to form raised regions and bringing an impermeable elongate security element into contact with the raised regions of the mould cover, prior to the contact entry point into a vat of aqueous paper stock. Where the impermeable security element makes intimate contact with the raised regions of the embossing, no fibre deposition can occur and windows are formed in the surface of the paper. After the paper is fully formed and couched from the cylinder mould cover, water is extracted from the wet fibre mat and the paper is passed through a drying process. In the finished paper the regions of the security element which are exposed in the windows are visible in reflected light on one side of the paper, which is commonly used for mainly banknotes.

The widespread use of security documents having security elements exposed on windows along the length of the element has resulted in enhanced security. A security document of this type provides this enhancement as, when viewed in transmitted light, the security element provides a different view from that which is seen under reflected light, where parts of the security element are readily visible in the window. However, there is a continual need for further enhanced security features to render the task of a would be counterfeiter more difficult.

One such development is described in GB-A-2323814 whereby a security element includes a reflective metal layer in the form of a design which consists of at least one repeating geometric pattern which the frequency, instantaneous amplitude or maximum amplitude of the pattern varies along the length of the element. Such complex fine line patterns are extremely difficult for counterfeiters to generate by the commonly used technique of foil blocking.

It is an object of the present invention to further enhance the security of security devices such as security elements.

According to the invention there is provided a security device for a security substrate, said device comprising a carrier of an at least partially light transmitting polymeric material, said carrier bearing a plurality of fine opaque lines separated by gaps, wherein the appearance of the lines is varied at regions, said regions in neighbouring lines combining to provide identifying indicia which are visible to the human eye.

The invention will now be described, by way of Example only, with reference to, and as shown in the accompanying drawings in which:

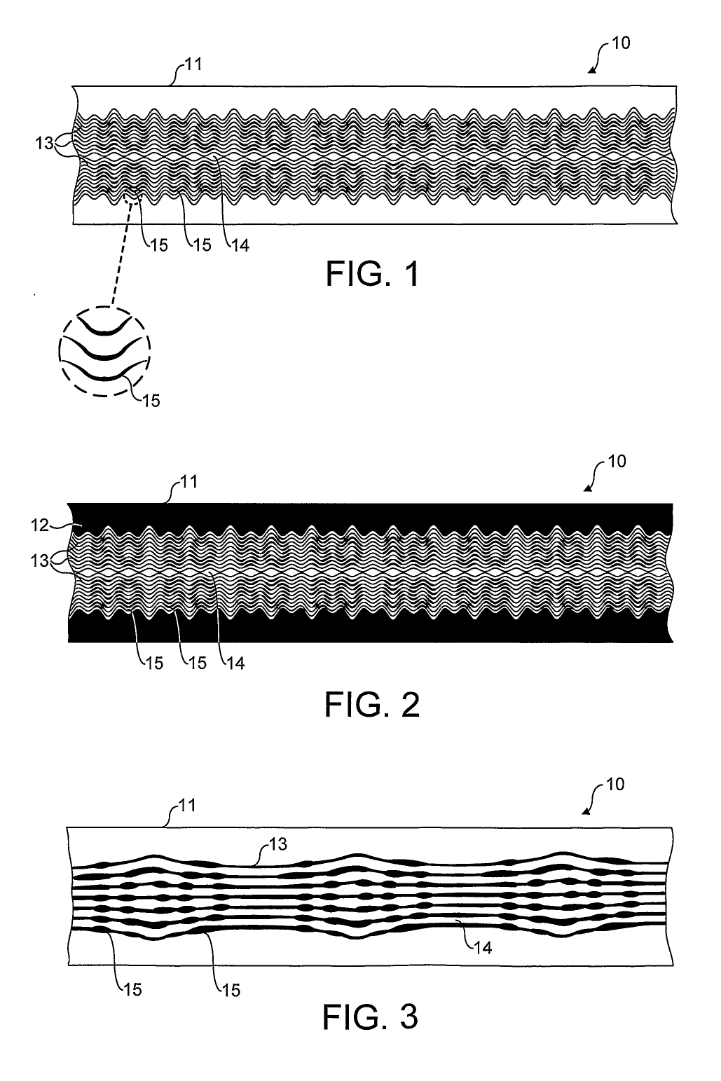

FIG. 1 is a plan view of a section of a security device according to the present invention;

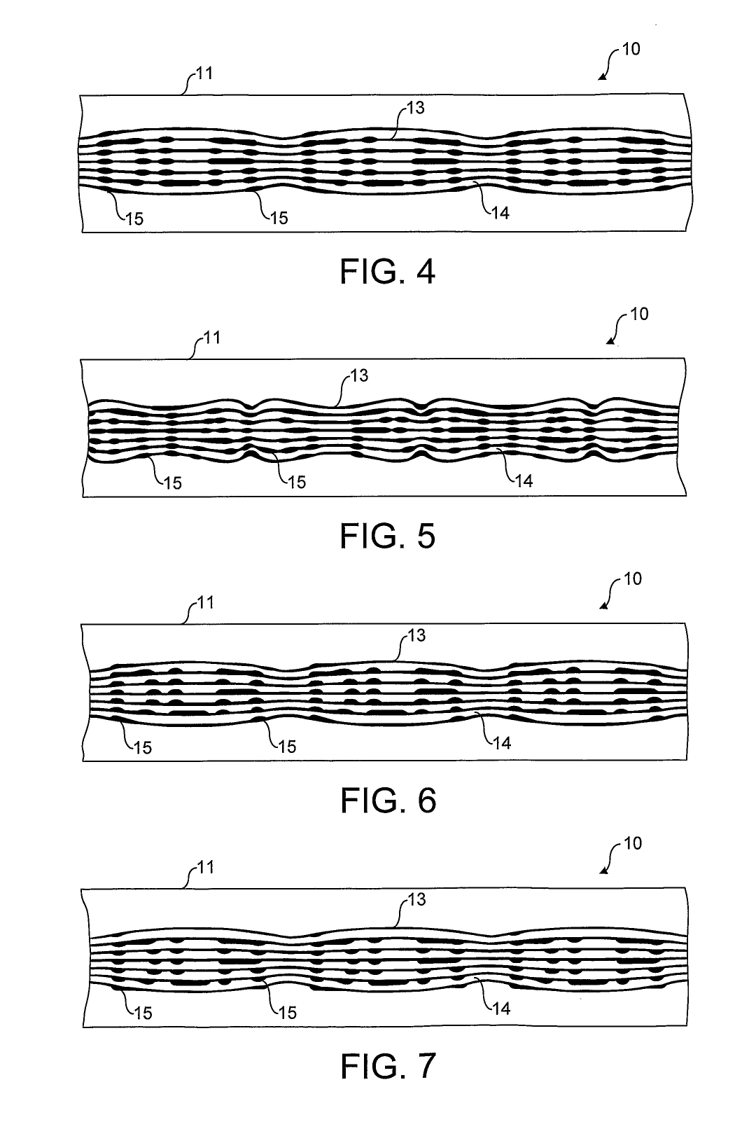

FIGS. 2 to 15 are plan views of sections of alternate security devices according to the invention;

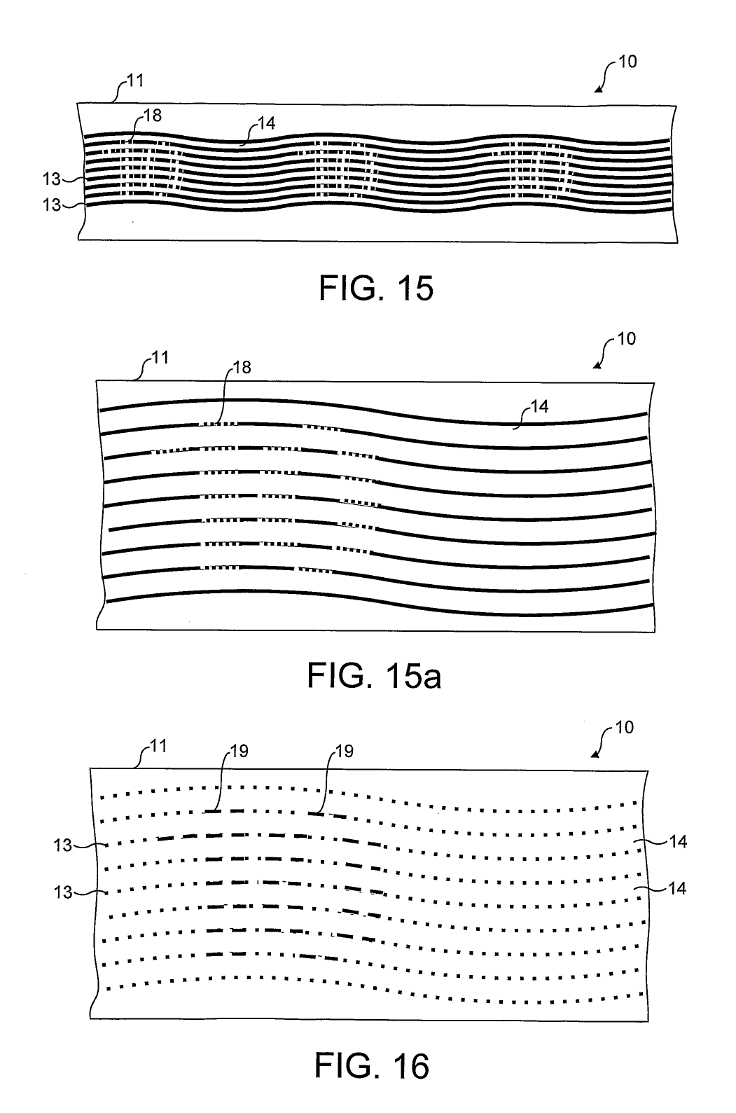

FIG. 15a is plan view of an enlarged section of the security device of FIG. 15;

FIG. 16 is a plan view of an enlarged section of another alternate security device according to the invention;

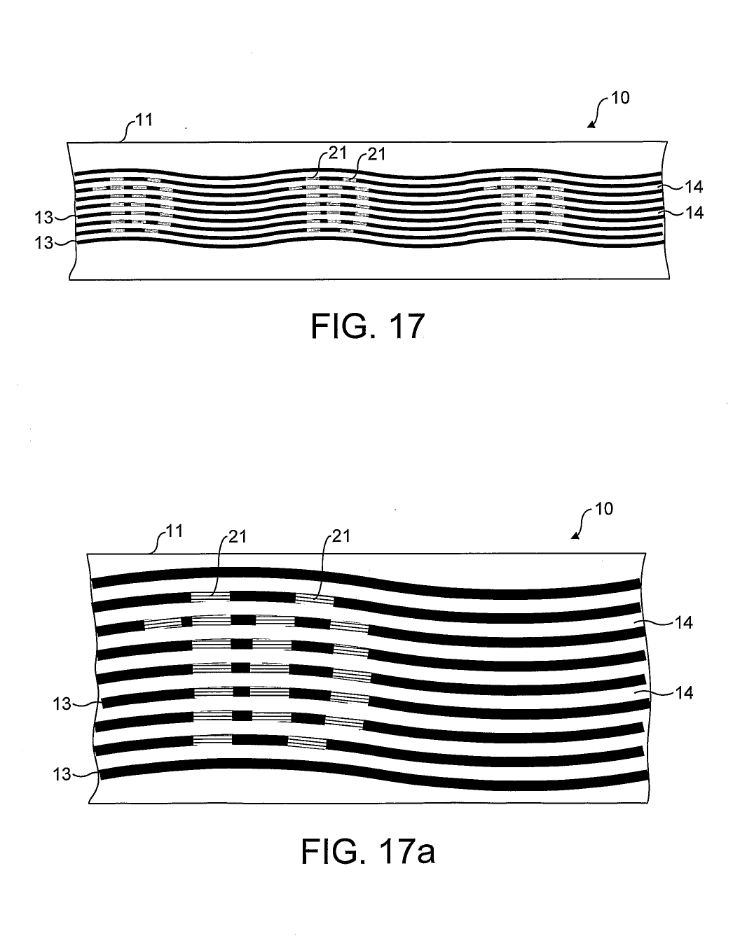

FIG. 17 is a plan view of a section of yet a further alternate security devices according to the invention;

FIG. 17a is plan view of an enlarged section of the security device of FIG. 17;

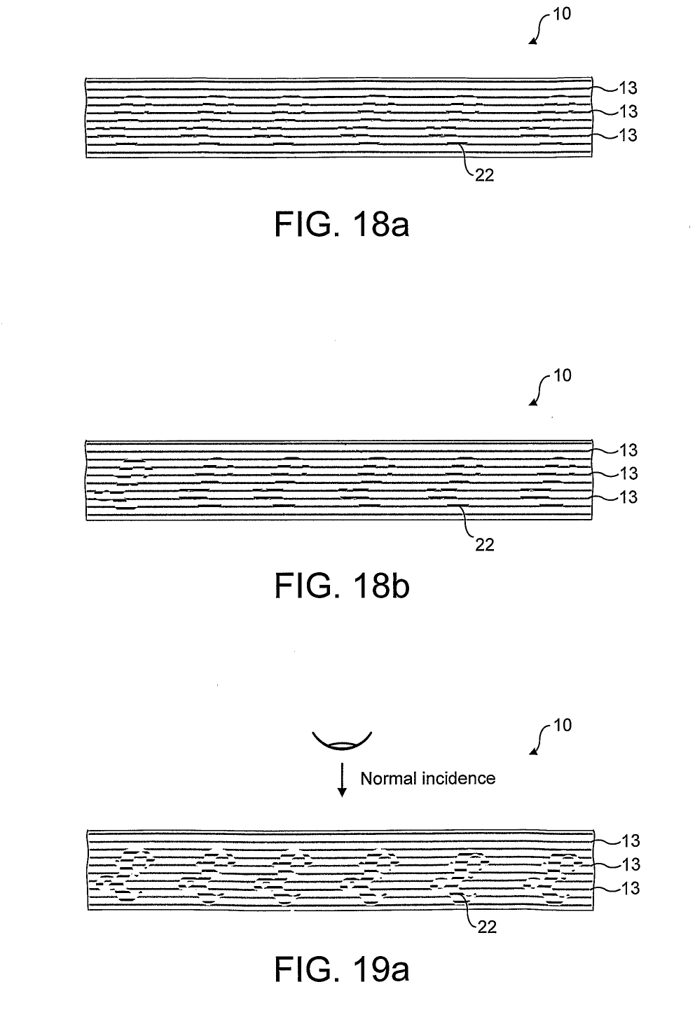

FIGS. 18a and 18b are plans views of sections of a further alternate security device incorporating a thermochromic ink prior to and after warming to an activation temperature; and

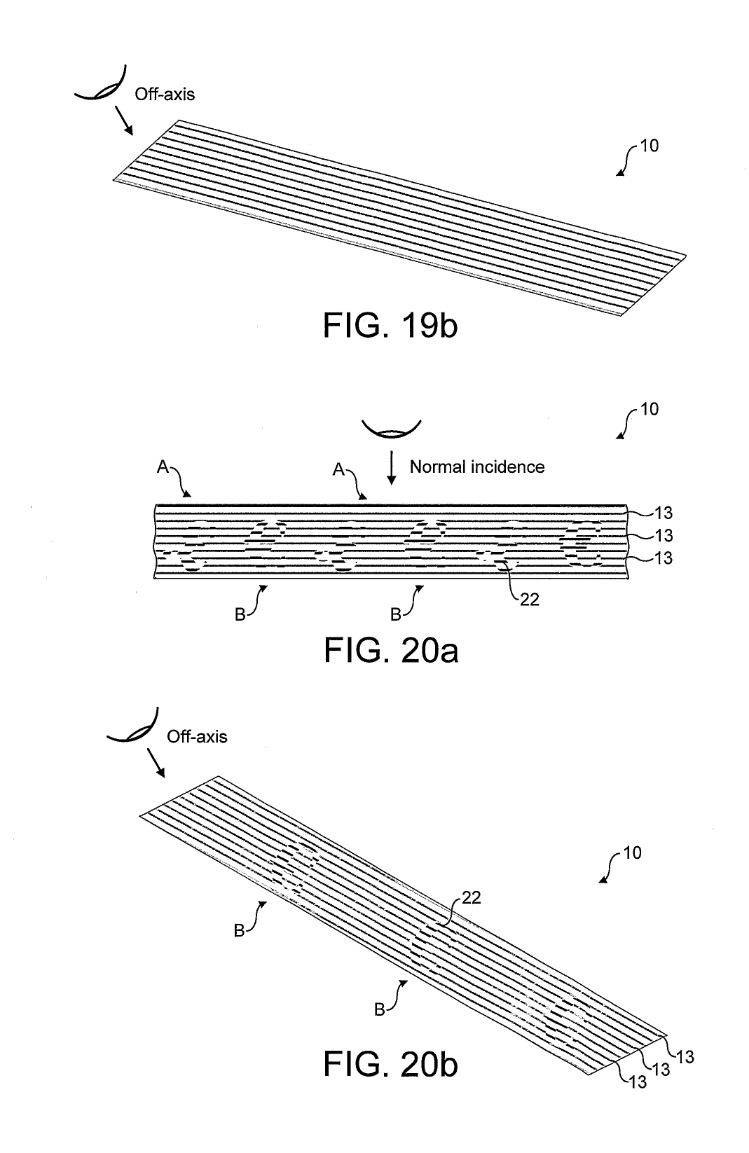

FIGS. 19a/19b and 20a/20b are plan views and perspective views of two section of different security devices according to the present invention showing angular dependence.

FIG. 1 shows a section of a security device in the form of an elongate element 10 according to a first embodiment of the present invention for partially embedding into a fibrous substrate, such as security paper.

The elongate security elements 10 are preferably inserted into a paper, or other substrate, so that they are either wholly or partially embedded within the substrate. Whilst the security element 10 can be used in wholly embedded or windowed form, the latter is preferred as the indicia are then easily recognisable in both reflected and transmitted light, rather than just transmitted light as in the wholly embedded form. The security element 10 is particularly suitable for use in a construction as described in EP-A-1141480 in which the configuration of the element 10 is wholly exposed at one surface of the substrate in which it is partially embedded, and partially exposed in windows at the other surface of the substrate.

The security device of the present invention is also particularly suitable for use in a construction described in EP-A-1536064 in which a protective band is incorporated into a paper web formed on a cylinder mould machine such that windows are formed on protruded elements on the face side of the web. A second paper web is applied to the backside to hide any defects formed as a result of incorporating the protective band. Alternatively the security elements 10 may be applied to the surface of the substrate.

The security element 10 has a base carrier 11 of a suitable plastic material and which is flexible and water impermeable, which is at least translucent and partially light transmissive, but preferably substantially transparent. A suitable material would be Polyethyleneterephthalate (PET). The carrier 11 is metallised to form a metal layer of aluminium or another suitable metal. This can be done by vacuum deposition, electroplating or another suitable method. The metallised carrier film 11 is partially demetallised using a known method, such as the resist and etch technique, to leave a series of, preferably substantially parallel, fine metallic lines 13. The metallic lines 13 are separated by demetallised gaps 14. The metallic lines 13 are preferably, but not necessarily substantially continuous along the length of the security element 10 to provide a conductive path along its length.

Preferably the lines 13 are non-linear and oscillate in the transverse direction of the security element 10 about a central axis as the lines 13 progress along the length of the element 10.

In some embodiments, as highlighted in FIGS. 13-17, the degree of oscillation is constant for each line. In an alternative embodiment, as shown in FIGS. 1-12, the degree of oscillation is not the same for each line with some or all of the lines having a different maximum amplitude relative to a central axis. Typically the lines 13 will exhibit the same profile but with maximum amplitude increasing for lines positioned further from the centre of the security element.

At intervals along the length of the metallic lines 13, their appearance is caused to vary. In this example, the thickness of the lines 13 is increased. The resulting regions 15 of increased width from each of the metal lines 13 co-operate with each other to form positive identifying indicia such as numerals, letters or pattern, visible to the naked eye in both reflected and transmitted light. In FIG. 1 the indicia shown are the numerals “50”, which repeat along the length of the security element 10.

The width of the metallic lines 13 is typically in the range of 0.025 millimetres to 1 millimetres, more preferably 0.1 to 0.5 millimetres. The line width is typically increased by a factor of up to 5 times in the increased width regions 15 and more preferably by a factor of 1.5 to 3 times. The number of lines per security element 10 is dependent upon the width of the security element 10 but, assuming that the whole active area is used, the following could be regarded as typical:

For a width of 4 mm=5-10 lines

For a width of 6 mm=7-15 lines

For a width of 8 mm=10-20 lines

For a width of 16 mm=20-40 lines

For a conventional windowed security element 10, having a width of up to 6 mm, the height and length of the indicia are preferably in the following ranges:

Height=2-5 mm

Length=2-8 mm

The length of the window will be dependent on the length and number of indicia that are to be viewed in the window. A typical window length, for a conventional windowed security element utlising the current invention, will be in the range of 4-12 mm.

In other constructions of the security element 10, the indicia could be significantly larger with a height range of 2-20 mm and a length of 2-30 mm. This is particularly applicable to security elements with the construction described in EP-A-1141480.

Typically elongate security elements 10 are slit from a wide web of filmic substrate having multiple threads across its width. The width of the security elements 10 is at least 0.5 mm and preferably at least 2 mm

The use of a demetallisation technique can mean that there is a solid metal region 12 at the extreme edges of the pattern formed by the metallic lines 13 as shown in FIG. 2. Such a design would allow a magnetic feature to be provided in the form of tramlines along the length of the thread under the metal regions 12, in a manner such as is described in EP-A-516790.

As an alternative to metallisation and demetallisation, inks, in particular metallic or metal effect inks and more preferably high reflectivity metallic or metal effect inks, may be deposited on the carrier 11 by a printing technique to form the lines 13. As a further alternate to metal effect inks, other optical effect inks can be used e.g. OVI® optically variable inks. Also transparent-coloured or opaque-coloured printing inks can also be used.

As another alternative, liquid crystal polymeric films or inks can be used. In this instance it is preferable to combine the liquid crystal materials with a darkly coloured background to enhance the colourshifting effect of the liquid-crystal. This can be achieved by printing the fine lines using a dark ink and then overprinting a liquid crystal ink e.g. Oasis® ink from SICPA or by application of a polymer liquid crystal film over the fine lines. Another approach would be as described in WO-A-03061980 where a metallised polymeric substrate is demetallised using the resist and etch technique where the resist is black or darkly coloured. A liquid crystal layer is then applied onto this darkly coloured resist.

FIGS. 3 to 5 illustrate alternative embodiments of the present invention having different indicia, which may be text instead of or in addition to numerals, and having different line patterns. It should be noted that the lines themselves may not be wholly parallel, as the gaps between adjacent lines may vary to a degree along the length of the security element 10. However they should preferably be at least partly parallel. In these examples the increased width regions 15 are formed by thickening the lines 13 on both sides. In FIGS. 6 and 7 two further embodiments of the present invention are illustrated in which the increased width regions 15 are formed by thickening the lines 13 on one side only.

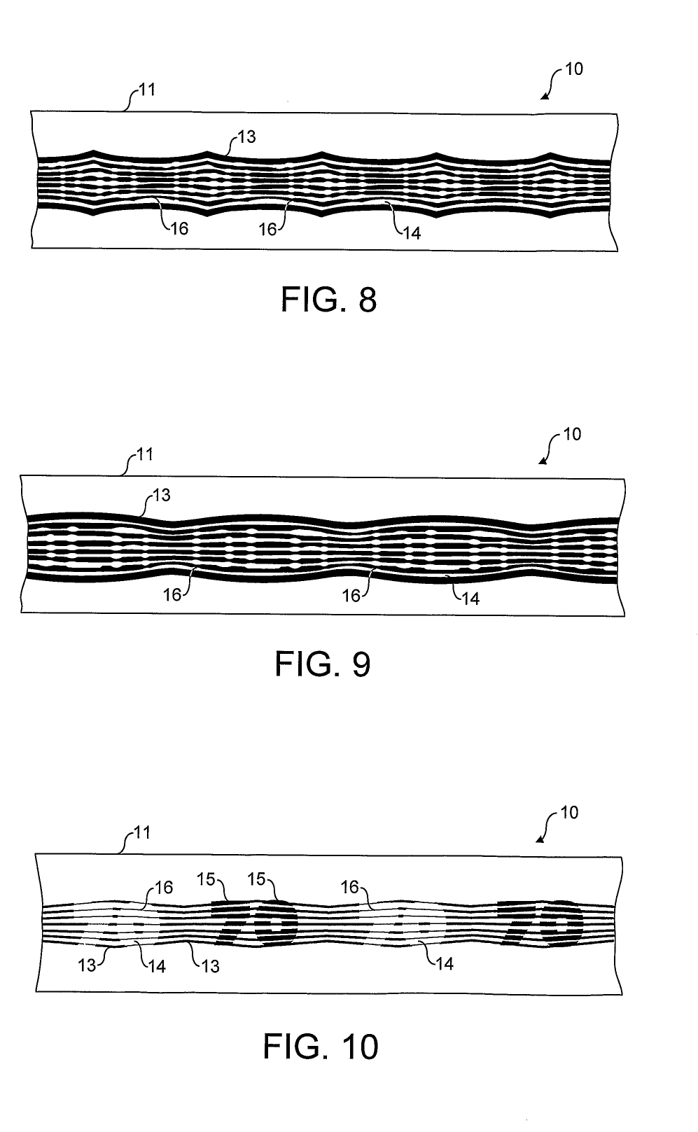

In the embodiments described previously, the indicia are positive indicia, i.e. being formed by the presence of additional metal. FIGS. 8 to 9 illustrate embodiments having negative indicia, whereby the appearance of the lines 13 is varied by decreasing the thickness of the lines 13 at intervals along their length. The resulting regions 16 of reduced width from each of the lines 13 again cooperate with each other to form negative identifying indicia. The line widths typically decreased by a factor of up to 5 times in the reduced width regions 16 and more preferably by a factor of 1.5 to 3 times. Although not illustrated, the extreme edges of the pattern can be metallised to provide solid metal region 12 as in FIG. 2.

FIG. 10 shows a further embodiment where the security element 10 comprises first regions where the lines 13 have regions of increased width 15 to form positive indicia and alternating second regions where the lines 13 have regions of reduced width 16 to form negative indicia.

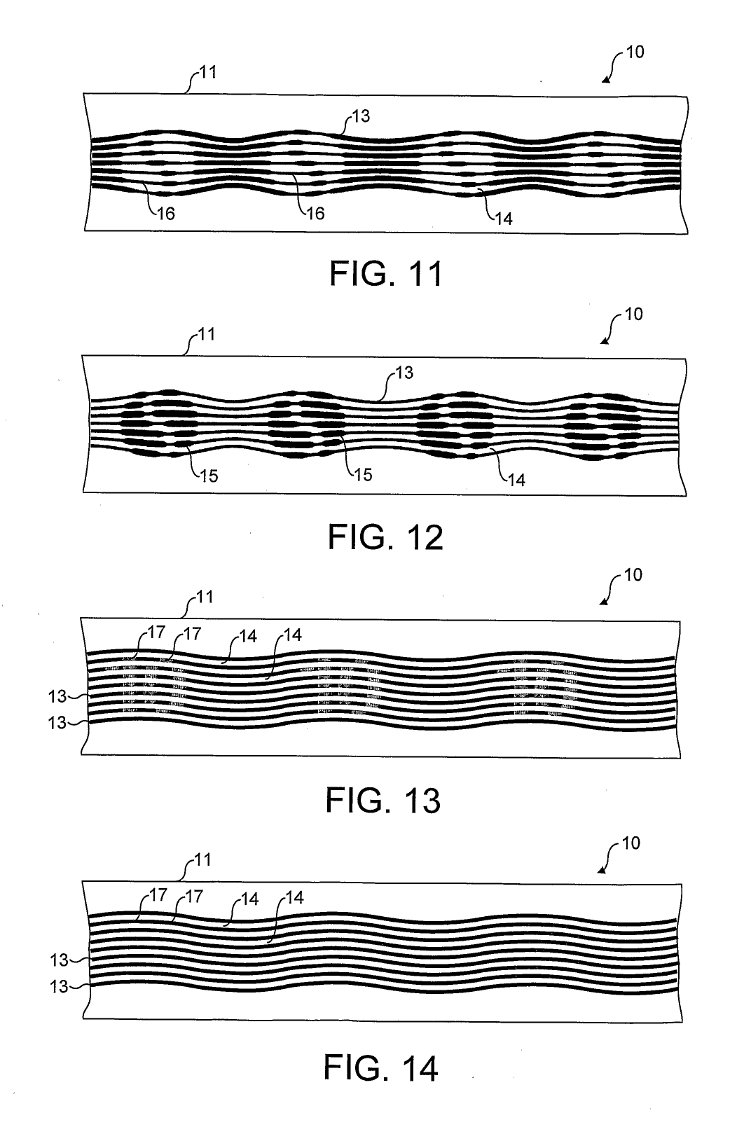

FIGS. 11 and 12 show further embodiments of the invention in which the indicia comprise a pictorial element, rather than alphanumerics. The lines 13 of FIG. 11 have regions 16 of reduced width, whereas those of FIG. 12 have regions 15 of increased width. In a further embodiment the security device 10 may have first pictorial elements formed as a result of increased width regions 15 and second pictorial elements formed as a result of reduced width regions 16.

Varying the thickness of the lines 13 is one method of locally modifying the visual appearance of the lines 13 in order to form the identifying information (alphanumeric or pictorial). Alternative methods of locally modifying the appearance of the lines 13 can be used to form the indicia, which include: a change in density/opacity, change in colour and change in continuity of lines (e.g. solid to dotted line).

FIG. 13 shows a section of a security device in the form of an elongate security element 10 comprising darkly coloured printed lines 13 which are continuous along the length of the security element 10. At localised regions 17 along the length of the lines 13 the opacity of the lines 13 is decreased to form the indicia or identifying information. Alternatively the opacity may be increased and there may be regions of increased and decreased opacity on the same security element 10. The same effect may be achieved with vapour deposited metallisation by locally varying the optical density of the metal layer.

FIG. 14 shows a section of a security element 10 comprising coloured printed lines 13 which are continuous along the length of the security element 10. At regions 17 along the length of the lines 13 the colour of the line 13 is changed to form the indicia or identifying information. Preferably the colour change is not significant, for example different tones of yellow; however, it is also possible to form indicia where the line colour is significantly different. The same effect may be achieved with vapour deposited metallisation by locally applying a different metal. For example the background lines 13 may be formed from vapour deposited Al and the regions forming the identifying information formed from vapour deposited Ni.

FIG. 15 shows a section of a security element 10 comprising metallised lines 13 which are continuous except in localised regions 18 where the lines 13 are made discontinuous to form the indicia or identifying information. The discontinuity may take the form of dots, as more clearly shown in the enlarged view in FIG. 15a, but may also be in the form of dashes oriented in the same direction as the continuous line 13. In an alternative embodiment the lines 13 maybe discontinuous along the whole length of the security element 10 with the nature of the discontinuity changed locally to form the identifying information. For example in FIG. 16 in the non-image areas the discontinuous line 13 is a dotted line but in the image areas the discontinuous line is a dashed line 19.

FIG. 17 shows an enlarged section of an elongate security element 10 comprising an array of parallel single continuous metallised lines 13 where in localised regions 21 the single line is split up into multiple lines to form the identifying information.

The above techniques for modifying the visual appearance of the lines 13 can be combined within the same security element 10 or other security device to produce more complex embodiments.

The present invention is not limited to lines 13 running substantially parallel to the long axis of the security element 10. In alternative constructions the lines 13 could be oriented substantially parallel to the short axis of the security device or the security device could comprise an array of lines for example in the form of a grid. In a grid structure the degree of line thickening can be varied for different line orientations to provide an optically variable image dependent on device rotation. For example, lines 15 parallel to the long direction of the security device can have the highest increase in thickness with a gradual reduction in the degree of thickening as the angle of orientation relative to the long direction of the security device is increased up to 90°.

In addition to displaying visual information, the variability in the line characteristics can be used to provide machine-readable information. For example in the thickened line embodiments the lines may be applied using a magnetic ink. The regions of increased width 15 would then exhibit an increased magnetic signal compared to the background line 13 and each portion of identifying information would contain a unique two-dimensional magnetic code that is very difficult to replicate. Alternatively the line 13 could be applied using a vapour deposited magnetic material for example Fe, Ni or Co.

The present invention may be combined with known methods for incorporating a magnetic component into a security device. For example, the line patterns may be restricted to the central region of the device with the metallised or printed regions extending up to the edge of the device as a solid area. This would allow the introduction of magnetic tramlines where the dark magnetic tramlines are concealed by the solid metallic areas.

The present invention may also be combined with other anti-counterfeiting materials, such as thermochromic materials, liquid crystal coatings or films, colourshifting inks, colourshifting interference films, holographic generating structures, luminescent, phosphorescent and fluorescent coatings and inks.

In a further embodiment, illustrated in FIGS. 18a and 18b, the security device in the form of an elongate element 10 comprises coloured printed lines 13 which are continuous along the length of the security element 10. At localised intervals along the length of the lines 13 the appearance of the lines 13 is varied by superimposing on the conventionally coloured printed lines 13 a thermochromic ink 22 to provide the identifying information. The thermochromic ink 22 is colourless below its activation temperature, and in this condition the identifying information is concealed (FIG. 18a). It should be noted that the colourless thermochromic ink is visible in FIG. 18a simply to aid understanding of this embodiment. On warming the element 10 to a temperature above the activation temperature the thermochromic material switches from a colourless state to a coloured state and thereby reveals the identifying information (FIG. 18b). In this embodiment, the colour of the thermochromic material is different to the coloured printed lines 13.

In a further embodiment the increased or decreased width regions 15, 16 of the security device 10, are formed using a thermochromic ink which switches from a colourless state to a coloured state at a certain activation temperature. Preferably the thermochromic ink in its coloured state has a similar colour to the unthickened line. On warming the device 10 to a temperature above the activation temperature the regions 15, 16 appear and reveal the identifying information.

In all the examples described previously the identifying information is oriented horizontally, i.e. for viewing in a direction parallel to the short axis of the security device 10 However it is also possible for the identifying information to be oriented vertically, i.e. for viewing in a direction parallel to the long axis of the security device 10 or at any intermediate orientation between the horizontal and vertical positions.

An additional advantage of the present invention is that the indicia or identifying information, formed from locally modifying the appearance of the lines 13 at intervals along the security device, has an angular dependent optically variable characteristic. The identifying information is visible when viewed normally (FIG. 19a) and remains visible when tilted away from the normal perpendicularly to the scroll direction. However when tilted parallel to the scroll direction the identifying information fade into the background and cannot be distinguished from the background scroll (FIG. 19b). This angular dependent characteristic is particularly beneficial for security devices for surface application, such as patches, stripes and wide threads incorporated into paper as described in EP-A-1141480.

FIGS. 3 to 7 compare examples where the lines 13 have been thickened symmetrically about a central point or where the lines have been thickened solely above or below a central line. If the location of the increased width region of the line 13 is always consistent the angular dependent optically variable effect, illustrated in FIGS. 19a and b, is particularly apparent. However in a more complex embodiment the location of the increased width region 15 within the same region of identifying information is alternatively above and below the central line. This enables the spacing between the lines 13 to be broken up such that when viewing off-axis and predominantly parallel to the scroll direction the identifying information can still be observed. If the security device 10, 20 contains two different regions of identifying information A and B (FIG. 20a and 20b), where region A is formed as a result of line thickening consistently above a central line and region B is formed as a result of line thickening alternatively above and below a central line then when viewed normally both regions A and B will be observed (see FIG. 20a). However when the security element 10 is tilted and viewed parallel to the scroll direction, region A will disappear and only region B will remain visible (see FIG. 20b). It should be noted that FIG. 20 is schematic and it is not intended to show accurately the positioning of the line thickening regions.

It is not necessary that the separate lines of the scroll pattern are of an equal thickness. For example the thickness of the background lines 13 can increase as they transverse across the security device 10. This introduces a further variant into the security device 10 and increases the resistance to counterfeiting.

The background scroll patterns and the identifying information can be linked in with the traditional banknote printed designs.

In a further embodiment of the invention, the different methods of locally modifying the visual appearance of the lines 13 in order to form the identifying information or indicia (alphanumeric or pictorial) can be combined within one security device 10, 20. For example regions of identifying information C formed by line thickening could be alternated with regions of identifying information D formed by localised discontinuities. The resultant contrast in the visual characteristic of the regions of identifying information further increases the security of the device.

For relatively simple scroll patterns, the line-thickened indicia is visible when viewed normally and becomes more visible viewed off-axis and viewed perpendicularly to the scroll direction. However when tilted parallel to the scroll direction the indicia fade into the background and cannot be distinguished from the background scroll

The use of a plurality of non-linear fine opaque lines 12 to create the indicia has the advantage over indicia formed by single solid lines in that the inventive security devices 10 are significantly more difficult to counterfeit. As a further benefit, they provide an aesthetically attractive appearance. Additionally where a continuous electrically conductive path is provided this means that the security devices 10 can be detected using conventional thread detection equipment on, for example, a used note sorting machine. The property of such security devices 10 being detectable with conventional metal detection equipment is a valuable property in helping to eliminate counterfeiting. Further, by provision of a suitable detector, the distribution of metal within the security device 10 may be determined by electrical or other means and compared to a reference pattern to provide a further technique for the authentication of a genuine document containing the security device 10.

The indicia or repeating pattern may be registered with the windows in the machine direction, so that an identical portion of the indicia or pattern is seen in each window. This requires the use of a registration process, such as that described co-pending application GB 0409736.6.

The security devices can be in the form of security elements, as described in more detail above, or patches, filaments, threads and the like and can be wholly embedded, partially embedded or applied to the surface of a substrate.

The finished security paper may be printed on one or both sides to identify the article or document formed from the paper. This printing may include a fine line pattern which matches the patterns of the lines 13. The fine line pattern on the security device and document may be registered with each other which would make it very difficult to counterfeit. The security device may have a tinted coat to match the colour of the paper or the printing itself to enhance the visual effect of the metallic pattern. Alternatively, the substrate may be coloured with a dye to match the printing.

1. A security device for a security substrate, said device comprising:
a carrier of an at least partially light transmitting polymeric material, said carrier bearing a plurality of fine opaque lines separated by gaps, wherein the appearance of the lines is varied at regions, said regions of varying appearance in neighbouring lines combining to provide identifying indicia which are visible to the human eye.

2. The security device as claimed in claim 1, wherein the lines form continuous paths along the length of the device.

3. The security device as claimed in claim 1, wherein the lines are metallic or produce a metallic effect.

4. The security device as claimed in claim 1, wherein the carrier is provided with a layer of vapour deposited metal and then partially demetallised to form the opaque lines.

5. The security device as claimed in claim 1, wherein the lines are printed.

6. The security device as claimed in claim 1, wherein the appearance of the lines is varied by increasing the width of the lines at said regions.

7. The security device as claimed in claim 1, wherein the appearance of the lines is varied by decreasing the width of the lines at said regions.

8. The security device as claimed in claim 6, wherein the appearance of the lines is varied by increases and decreases in the width of the lines in said regions.

9. The security device as claimed in claim 1, wherein the appearance of the lines is varied by varying the opacity of the lines at said regions.

10. The security device as claimed in claim 1, wherein the appearance of the lines is varied by varying the density of the lines at said regions.

11. The security device as claimed in claim 1, wherein the variation in the appearance of the lines is effected by varying the colour of the lines at said regions.

12. The security device as claimed in claim 1, wherein the variation in the appearance of the lines is effected by making the lines partly discontinuous.

13. The security device as claimed in claim 1, wherein the variation in the appearance of the lines is effected by splitting the lines into a plurality of smaller lines.

14. The security device as claimed in claim 1, wherein the variation in the appearance of the lines is effected by the activation of an activatable material selected from the group consisting of a fluorescence, thermochromic, photocromic, luminescent and phosphorescent material.

15. The security device as claimed in claim 1, wherein the variation in the appearance of the lines is caused by the use of an optically variable medium selected from the group consisting of a liquid crystal material, a colourshift or irridescent material, a diffraction pattern, an interference film and a holographic generating structure.

16. The security device as claimed in claim 1, wherein the variation in the appearance of the lines is effected by a combination of the effects selected from the group consisting of increasing the width of the lines at said regions, decreasing the width of the lines at said regions, increases and decreases in the width of the lines in said regions, varying the opacity of the lines at said regions, varying the density of the lines at said regions, varying the colour of the lines at said regions, making the lines partly discontinuous, splitting the lines into a plurality of smaller lines, activating an activatable material, and using an optically variable medium.

17. The security device as claimed in claim 1, wherein the regions provide a machine readable characteristic.

18. The security device as claimed in claim 1, wherein the lines are substantially non-linear along the length of the security substrate.

19. The security device as claimed in claim 18, wherein the lines oscillate in the transverse direction of the security substrate.

20. The security device as claimed in claim 19, wherein some or all of the individual lines have different degrees of oscillation.

21. The security device as claimed in claim 1, wherein the width of the lines outside the regions in which the appearance of the lines is varied is in the region of 0.025 to 1.0 mm.

22. The security device as claimed in claim 21, wherein the width of the lines outside the regions in which the appearance of the lines is varied is in the region of 0.1 to 0.5 mm.

23. The security device as claimed in claim 1, wherein the width of the lines is increased or decreased by a factor of up to 5 in the increased width regions.

24. The security device as claimed in claim 23, wherein the width of the lines is increased or decreased by a factor of between 1.5 and 3 in the increased or decreased width regions.

25. A security substrate comprising a security device as claimed in claim 1 wholly or partially embedded in the substrate.

26. The security substrate as claimed in claim 25, further comprising windows in at least one surface of the substrate at which are exposed regions of the security device.

27. A security substrate comprising a security device as claimed in claim 1 applied to the surface of the substrate.

28. A security article formed from the substrate of claim 25, further comprising printing on at least one surface of the security substrate.

29. The security article as claimed in claim 28, wherein the printing on the surface of the security substrate comprises a pattern of lines which matches the pattern of lines on the security device.

30. The security article as claimed in claim 28, further comprising a banknote.

31-33. (canceled)
